(19) United States
(12) Patent Application Publication
(10) Pub. No.: US 2006/0266038 A1
(43) Pub. Date: Nov. 30, 2006

(54) Machine and system for power generation through movement of water

(76) Inventor: Wayne F. Krouse, Houston, TX (US)

Correspondence Address: JAMES D. PETRUZZI, 4900 WOODWAY SUITE 745, HOUSTON, TX, 77056, US

(21) Appl. No.: 11/446,497

(22) Filed: Jun. 2, 2006

Related U.S. Application Data
(63) Continuation-in-part of application No. 11/137,002, filed on May 25, 2005.
Application No. 11/137,002 is a continuation of application No. 10/851,604, filed on May 21, 2004, now Pat. No. 6,955,049.
(60) Provisional application No. 60/474,051, filed on May 29, 2003.

(51) Int. Cl. F03G 7/04

(52) U.S. Cl. 60/641.7

(57) ABSTRACT

A system for power generation through movement of water having an array of power generating cells hydraulically interconnected where the array is composed of cells in a interchangeable modular arrangement, the cells are positioned to receive kinetic energy from the movement of water, and the cells convert the energy by the movement of water through a turbine that drives a hydraulic pump. The hydraulic pumps may be hydraulically isolated from each other and are connected through a hydraulic motor to a generator which may be an AC synchronous induction motor. The power generating cell may also be comprised of a single turbine and hydraulic pump combination that in turn drives a motor.

### CROSS REFERENCE TO RELATED APPLICATIONS

This is a continuation in part of pending application Ser. No. 11/137,002 filed May 25, 2005, which is a continuation of application Ser. No. 10/851,604 filed May 21, 2004, now issued as U.S. Pat. No. 6,955,049 which is related to provisional patent application No. 60/474,051 titled “A Machine for Power Generation through Movement of Water,” filed on May 29, 2003, which is hereby incorporated by reference as if fully set forth herein.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF INVENTION

This invention relates generally to the field of power generation and more specifically to a machine and system for power generation through movement of water.

### BACKGROUND OF THE INVENTION

Extraction of energy from water sources has been a desire of mankind for ages. Various methods involve water wheels, entrainment, and hydroelectric turbines. Prior attempts to convert ocean tidal movements or current into power involve large scale systems, the use of traditional generators and various turbines to capture the power of the water.

The deficiency in the prior art is that the systems are not easily configurable for different settings, require large scale construction and are not commercially viable. They are not suitable to being moved easily, they are not topographically adaptable, nor do they withstand the corrosive effects of water. Further, the weight needed for a traditional generator having magnets and copper wire inhibits replacement. Moreover, there has been no system using an array of small power cells arranged in parallel to capture the movement of the ocean, rivers or other current in such a way as to combine relatively small generators into one large power production system. There also has not been the efficient use of hydraulic pumps and turbines alone or in combination to generate electricity from water movement.

### BRIEF SUMMARY OF THE INVENTION

A water driven turbine is used to extract electrical energy from the moving water (wave, current, tidal or other). A turbine fan will rotate independently in a converging nozzle to extract additional energy from moving water after each independent turbine fan. The fan blades rotate independently inside of a housing. The housing contains windings made of copper or a conductive polymer or other conductive material. Rotating magnetic field produced from a magneto polymer, particulate materials that generate a magnetic field suspended in a homogeneous or heterogeneous polymer or traditional magnetic material such as Fe, Co Ni, Gd, Sn, Nd or ceramics that exhibit magnetic fields generates electrical energy as the independent turbine containing the magnetic material passes by the conductive windings. The magneto polymer differs in that the magnetic characteristic exists at the atomic level as opposed to a particulate mixture suspended in a polymer. The truss structure in the polymer housing is composed of polymer or fiberglass reinforced polymer, carbon composite or nanotube reinforced polymer. The truss structure supports the central shaft of the turbine blade assembly inside of the polymer turbine housing. Electrical energy that is generated in each turbine should be in the range of 0.001-5,000 watts (W) but could be as large as 100,000 W per turbine. The electrical energy is transferred from the winding of each turbine and connected in parallel to a power transfer conduit internal to each of the turbine housings composed of copper wire or electrically conductive polymer. The power is transferred from one turbine housing to the next via the internal conduit until it can be transferred to a collection system for metering and eventual transfer to the grid. If one generator generates between 0.001-100,000 W, then a plurality of generators connected in parallel in a two dimensional array has the potential to generate commercial quantities in the multiple megawatt (MW) range. Since this system is made of polymer, ceramic or nonferrous coated metal, and any potentially magnetic part internal to the turbine does not contact the water directly, it does not corrode, it is light weight, it is portable, it is cheap to manufacture and replace and topographically configurable. Additionally, the array's modular (cellular) design allows for repairs and maintenance of the turbines without taking the entire power generating capacity of the array offline. Realistically, only a fractional amount of power generating capacity would be taken offline at any one time as only individual vertical stacks in the two dimensional array would be taken offline for maintenance of a turbine in that stack.

In accordance with a preferred embodiment of the invention, there is disclosed a a machine for power generation through movement of water having an array of power generating cells electrically interconnected, where the array is composed of cells in a interchangeable modular arrangement and the cells are positioned to receive kinetic energy from the movement of water, wherein the cells convert energy by the movement of an electrical turbine within each cell.

In accordance with another preferred embodiment of the invention, there is disclosed a machine for power generation through movement of water having a housing with electrically conductive windings, an impeller displaced within the housing having polymer magnetic elements that create induced electrical energy upon rotation of the impeller within the housing, and blades on the impeller for receiving kinetic energy from water wherein the impeller is motivated by the movement of water across the blades.

In accordance with another preferred embodiment of the invention, there is disclosed a system for power generation through movement of water having a plurality of turbines with magnetic polymer displaced in an impeller of a the turbines, where the impellers are surrounded by electrically conductive windings displaced in a housing about the impellers, the turbines are arrayed in a modular arrangement and electrically interconnected where the impellers are motivated by the movement of water to generate electricity.

In accordance with another preferred embodiment of the invention, there is disclosed a system for power generation through the movement of water having a plurality of energy cells, each cell individually producing less than 5000 Watts each, a tray for holding said cells in electrical communication through an electrical conduit internal to the polymer with one or more of the cells, the cells are arranged in vertically stacked arrays in the ocean and transverse to the ocean tidal movement, and the arrays are electrically connected to the electrical grid.

In accordance with another preferred embodiment of the invention, significant additional advantages are achieved through the use of hydraulic pumps that are driven by water turbines. By using a platform mounted hydraulic pump system connected to a turbine with converging and diverging ducts at the inlet and outlet of the turbine, respectively, and with dual ducting or singe ducted turbine designs, the system can be easily adapted to environmental conditions and permits ease of servicing or repair. The hydraulic fluid can be incompressible and biodegradable for offshore applications. The hydraulic pumps are connected to a hydraulic motor which in turn drives an AC induction motor that can be finely controlled using governor valves and electronic computer control. This system may configured in an interchangeable array of pumps and turbines or be achieved with a single turbine and hydraulic pump combination, or other permutations thereof that drive a motor for generating electricity.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a graph illustrating average current velocity as a function of water depth in an ocean deepwater zone.

FIG. 2 is a graph illustrating water velocity as a function of water depth in an ocean breakwater zone.

FIG. 3 is a schematic diagram illustrating an array of power cells for a commercial scale generation site.

FIG. 4 is a schematic diagram illustrating a vertical stack of cells in a portion of an array oriented for uni-directional flow in a deepwater zone.

FIG. 5 is a schematic diagram illustrating a vertical stack of cells in a portion of an array oriented for bi-directional flow in a deepwater zone.

FIG. 6 is a side elevational view of a conical impeller having a plurality of fan blades in a single stage set in a housing for electrical connection in an array.

FIG. 7 is a front end elevational view of an impeller with a plurality of blades.

FIG. 8 is a schematic diagram illustrating an electricity connection tray for electrically mounting stacks of cells.

FIG. 9A is a schematic diagram illustrating an array of bi-directional cells oriented orthogonally to the flow of ocean water.

FIG. 9B is a schematic diagram illustrating an array of bi-directional cells with anchors and flotation marker and electrical connections.

FIGS. 10A through 10D show several views of a conical turbine generator and an electricity collection tray for creating an array of cells.

FIGS. 11A and 11B show a side and front/back view of a turbine generator having a plurality of impellers.

FIG. 12 shows a group of arrays of power generating cells electrically connected to the grid.

FIG. 13 shows a side view of a turbine with converging and diverging inlet and outlet nozzles respectively, connected to a hydraulic pump combination according to a preferred embodiment of the invention.

FIG. 14 shows a schematic diagram of a series of turbine driven pumps, generator and hydraulic motor according to a preferred embodiment of the invention.

FIG. 15 shows a perspective view of platforms with hydraulic pumps according to a preferred embodiment of the invention.

FIG. 16 shows a perspective view of a system of hydraulic pumps on a plurality of platforms positioned beside a dam to receive energy from water movement and an associated power station.

FIG. 17A shows a perspective schematic view of a dam, non-electrified dam, and spillway coupled with turbine driven hydraulic pumps for generation of electricity.

FIG. 17B shows a side view of an array of turbines positioned in a spillway for generation of electric power with turbine driven hydraulic pump.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a representative basis for teaching one skilled in the art to employ the present invention in virtually any appropriately detailed system, structure or manner.

Turning now to FIG. 1, there is shown a graph depicting average or mean current velocity 10 as a function of water depth 12 in the ocean deepwater zone. It is observed that velocity is relatively constant in deepwater zones, between some upper and lower limits, and for certain purposes may be a source of water energy applicable to the present invention. The Gulf Stream in the Atlantic Ocean and Kuroshio Current in the Pacific Ocean provide examples of steady deepwater current that the present invention could utilize to drive a plurality of cells arrayed as further described herein. However, in a deepwater zone, it is difficult to harness the water power and maintain an array of power generating units. In contrast, the water movement in a breakwater zone, a non electrified reservoir, a river or aqueduct are more amenable to the advantages and benefits of the current invention.

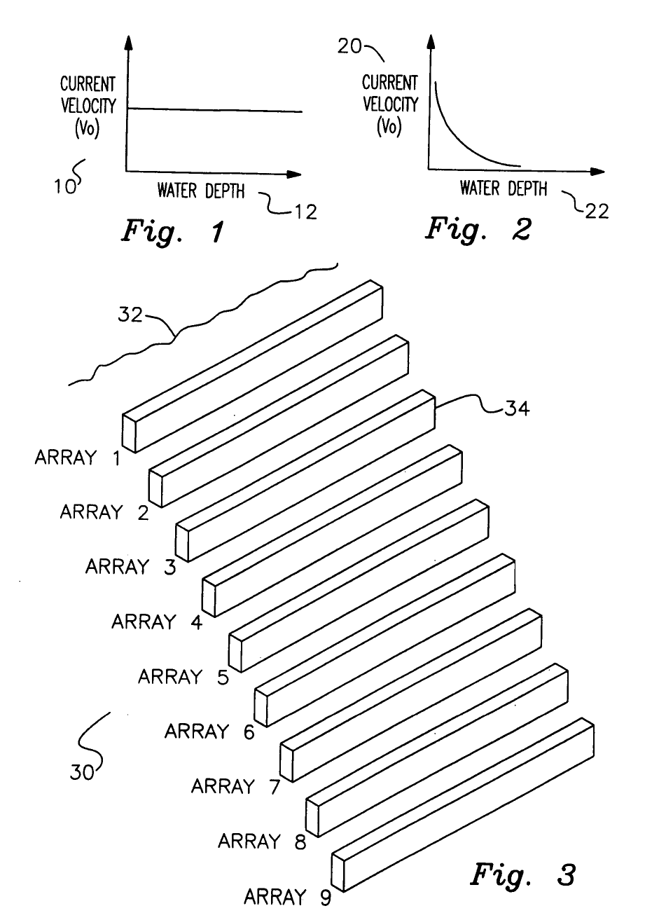

FIG. 2 shows a graph depicting water velocity 20 as a function of water depth 22 in an ocean's breakwater zone. It is observed that as water depth decreases, i.e. as the wave approaches the shore, the velocity of the water increases to dissipate the energy contained in the wave. This provides a ready and renewable source of energy for an array of cells of the type described herein. As will be more fully appreciated below, the presence of shoreline energy capturing systems as shown herein, benefit from this phenomenon to create cheap and reliable energy. This method will work for any accessible moving body of water with fairly constant velocity for a given cross sectional area.

FIG. 3 shows an array set 30 that are aligned in a preferred embodiment of the present invention. Array set 30 is comprised of a series of individual arrays 34, which are deployed in the breakwater zone parallel to a beach 32 in an ocean's breakwater zone to receive the movement of tidal water. Such arrays could be aligned transverse to the flow of a river to take advantage of the prevailing current, in a deepwater zone that might benefit from a current movement or in other locations to take advantage of localized current. Each array 34 is a series of stacked energy cells that are driven individually by the movement of water through energy cells that are stacked together in some fashion. The cells are interconnected through an electricity connection tray (see FIG. 8) so that each array set 30 generates a summing of electrical energy from the energy cells. The array set 30 is then eventually connected to the power grid.

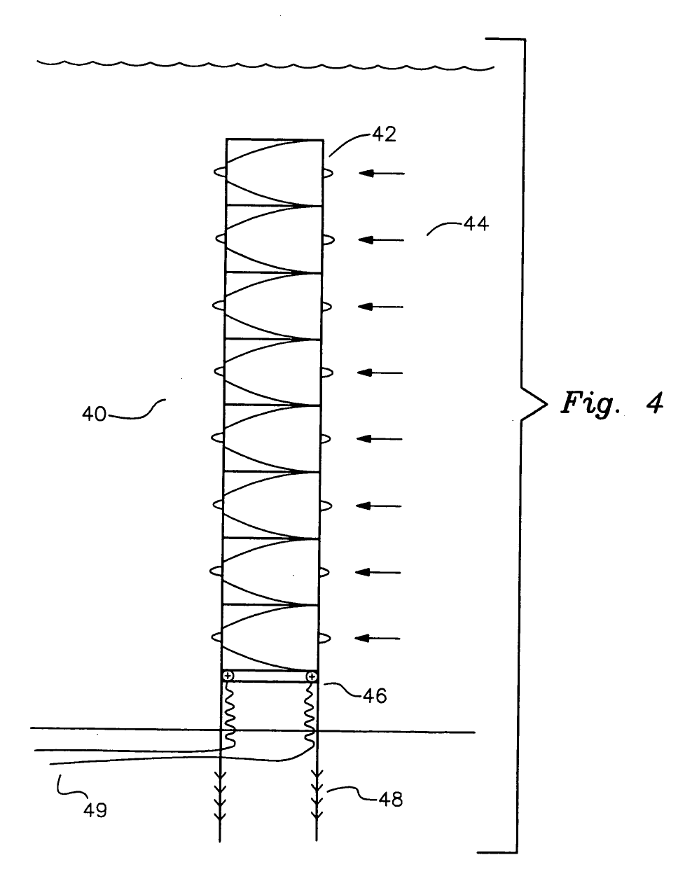

FIG. 4 shows a side view of a single stack 40 of energy cells 42 in a larger array as depicted in FIG. 3. FIG. 4 shows a single stack 40 of energy cells 42 for reception of unidirectional water flow in a deepwater zone or river, or even a breakwater zone. As water flows across the energy cells shown by left pointing arrows 44, energy cells 42 receive kinetic energy which in turn generates power. The individual energy cells 42 are stacked and electrically interconnected at positive and negative poles 46 to generate power that is transmitted over lines 49 to an inverter or the power grid. Each individual energy cell 42 may produce a small amount of energy but stacks 40 of energy cells 42 connected in parallel produce substantial energy. Stack 40 may be moored at anchor 48 in the ocean floor by conventional means well known in the art. The arrays thus arranged are flexible and float in the water while at the same time presenting themselves transverse to the water flow for maximum power generation.

A significant advantage of the modularization of the power array is the use of small power devices which in a preferred embodiment may have power outputs on the order of 0.001-5000 W. This permits the use of devices that may be significantly smaller than typical power generating turbines on the scale of 0.001 in 3 to 50,000 in³.

By using such small devices, the creation of a large array is greatly facilitated and permits the ready exchange of non-functioning devices without affecting the power generation for any period of time. Such miniaturization of the power generating devices may be termed a micro-generator or micro-device. The combination of a multiple devices into an array has an output when summed that is equal to a much larger single generator.

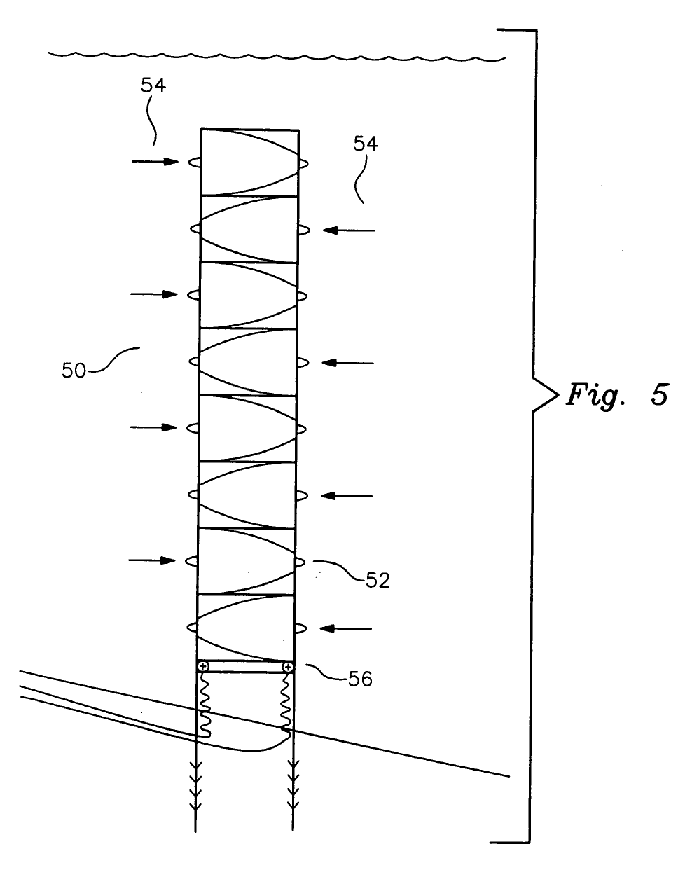

FIG. 5 shows a single stack 50 of energy cells 52 for maximum reception of the bi-directional water flow in a breakwater zone. As water flows across the energy cells 52 shown by the left and right pointing arrows 54, energy cells 52 receive kinetic energy which in turn generates power. Water flow may be through tidal action having the ebb and flow in two directions thereby activating cells designed and positioned to benefit from both directions of water movement. FIG. 5 shows a side view of one stack 50 of cells 52 in a larger array as depicted in FIG. 3 with the cells electrically interconnected by positive and negative poles 56 in similar fashion as described in FIG. 4.

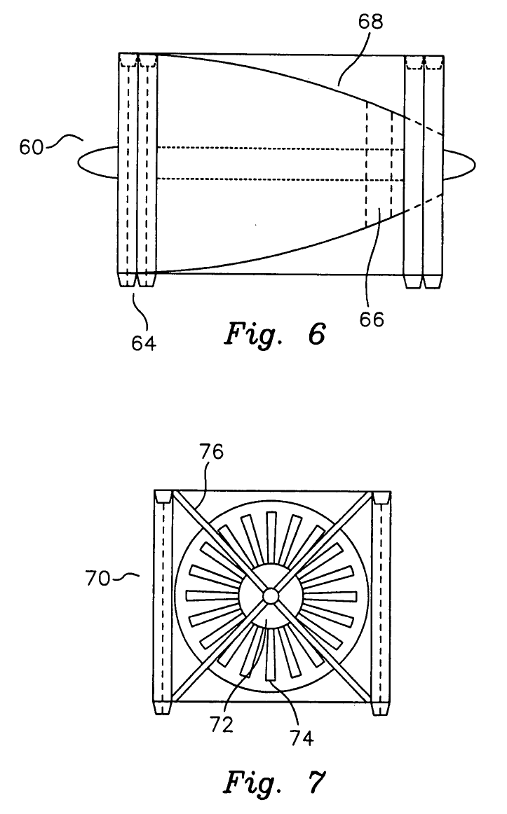

FIG. 6 show a side view of a single cell impeller 60 having a plurality of fins (see FIG. 7) for converting kinetic energy into electrical energy. The individual cell is configured for electrical connections 64 to other cells in parallel fashion creating a cumulative power generation. The impeller 60 (or turbine) is situated in a housing that is properly configured to generate electricity. The housing has a cross brace (depicted in FIG. 7) for added stability. The generator is created by having magnets or magnetic material positioned in the housing for the blades and positioning windings in the housing surrounding the impeller 60. As the impeller 60 is turned by the action of the water, an electromagnetic force is created imparting current on the windings and in turn generating electricity. By configuring the cells in parallel electrical connections, the small amount of energy generated by an individual cell are added together to produce a larger amount of electrical energy.

In a preferred embodiment using conventional polymer fabrication means well known in the art, turbines and housings may be manufactured where magnetic polymers or magneto polymers are used to replace standard magnets and copper windings. The amount of magnetic polymer or magneto polymer used and its proper location are a function of the degree of magnetic attraction desired for the particular application. Magnetic forces and conductivity sufficient to generate the wattages desired herein are achievable using such materials and result in a generator that is lightweight and impermeable to the corrosive forces of water.

A single turbine may be fitted with independent blade rings 66 to allow extraction of maximum work along the longitudinal axis and the turbine may be tapered along its outer circumference 68 to increase velocity of flow due to the constricting of the nozzle in the turbine.

FIG. 7 shows an end view of a single turbine housing 70 and impeller 72 with a plurality of fan blades 74, beneficial for capturing the maximum amount of energy from the movement of water. Cross brace 76 provides added stability.

FIG. 8 shows an electricity connection tray 80 for affixing multiple cell stacks to create the larger arrays shown in FIG. 3. Tray 80 has electrical post channels positive 82 and negative 84 for making electrical connection to the stack of cells. Each group of vertically stacked cells is placed on a tray. First vertical stack 85, Second vertical stack 86 and N vertical stack 88 is placed one next to the other in electrical parallel connections 82 and 84 and in turn, the adjoining stacks of cells are electrically interconnected through the stacking base. As can readily be seen, tray 80 may accommodate a plurality of vertical stacks all electrically interconnected. Thus, any number of vertical stacks may be arrayed in this fashion and each stack may be of any of a number of cells as desired for the particular application. Such a polymer transfer plate may be mounted on the top of a plurality of cells for additional stacking, to provide electrical interconnection and thus permit transfer of power from an array to a rectifier/inverter and then to a grid. This arrangement permits ready installation and ease of repair.

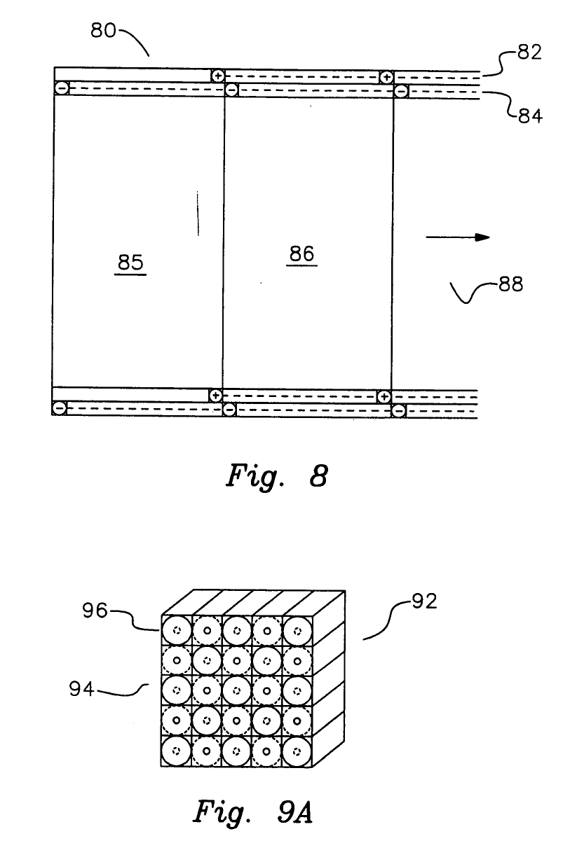

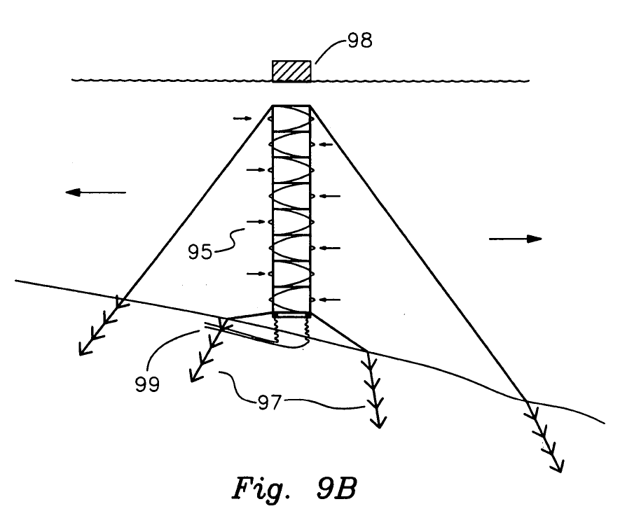

FIG. 9A shows a perspective view of cell array 92 having a plurality of cells aligned to either to receive the flow of water from the ocean side 94 or to receive the flow of water from the beach side 95. By arranging the cells in this fashion, individual cells are positioned to maximally convert the kinetic energy from the ebb and flow of the water. In this embodiment a particular cell is aligned either in one direction or the other and its power generating turbine spins optimally when receiving the direction of flow for which it was designed.

FIG. 9B shows a side view of an overall arrangement of cells for receiving bi-directional flow in a stack of cells that are electrically interconnected as herein described. The stacks are preferably mounted on sturdy but lightweight housings 95 to resist the flow of ocean water and maintain stability in inclement weather. The array of cells may be affixed to the ocean floor by anchor 97 to provide greater stability. A floatation device 98 may be employed for orientation and location purposes. The cells are preferably mounted on stack trays to create an array and then are electrically summed through the operation of the electrical connection to generate power which is transmitted onward. The accumulated energy produced from the array of cells may be conveyed through conventional wire 99 means to a grid, through superconducting cable, or other electrical conveyance means well known in the art.

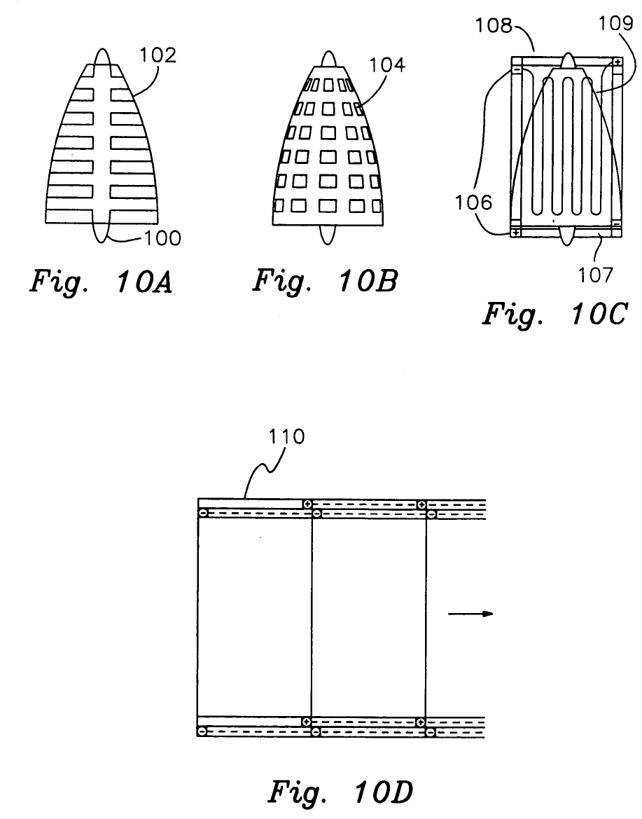

FIGS. 10A, 10B, 10C and 10D show views of a conical turbine generator having central shaft 100 and disposed about the shaft are a plurality of impeller blades in multiple stages such as stage 102. In certain embodiments, it may be preferable to have a single stage. The impeller housing has magnets 104 inserted therein or magnetic polymer imbedded in the housing. The exterior housing 108 of the turbine has terminal pass through electrical connectors 106 and a rigid support 107, which allows for stacking of individual units. FIG. 10D also shows an electricity collection tray 111 for creating an array of cells. The tray has electrical connections through copper wire or conductive polymer 109.

An innovative construction of the turbines is achieved by the use of polymers for use in polymer molds for mass production of each individual turbine. The magnetic elements of the turbine will have embedded in the turbine one of a variety of materials among them ferrous, ceramic, or magnetic polymer (magneto polymer rare earth magnets (NdFeB) types. The use of electrically conductive polymer for cathode and anode within embedded transmission system in device and device array reduces weight and makes the manufacture of small turbines efficient and economical. Further, the use of such turbines will create zero production of CO2, CO, NOx, SOx, or ozone precursors during power generation. The impeller design shown in FIG. 10 is engineered in polymer to extract maximum work in tandem use with a converging housing or nozzle.

Use of polymers for corrosion resistance, low cost manufacturing and mass production and the use of polymers for impeller blades or for multiple but independent impellers may be desired. The use of polymers for use in polymer molds for mass production and the use of the following magnet types in a polymer generator for use in generating power from the ocean: ferrous, ceramic, magnetic polymer (magneto polymer rare earth magnets (NdFeB) types. Further the use of electrically conductive polymer for cathode and anode within embedded transmission system in device and device array;

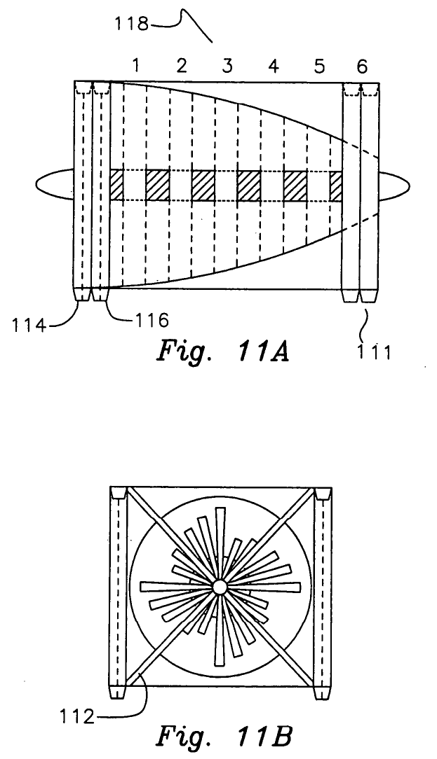

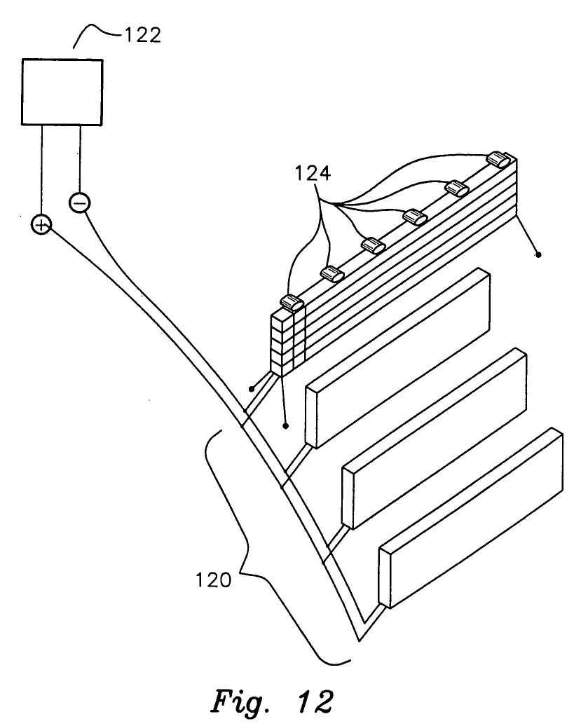

FIGS. 11A and 11B show a side and front/back view of a turbine generator having a plurality of impellers in several stages. In certain embodiments, it may be preferable to have a single stage to extract energy. The turbine is housed in an electrically interconnectable base 111 to allow for stacking of multiple cells in a vertical fashion and as part of a larger array. The cross brace 112 provides added support. Copper wire windings or conductive polymer windings would be configured about the impeller to produce current when magnets or magnetic material imbedded in the impeller housing spin with the turbine impeller producing magnetic flux.

FIG. 12 show a group of arrays 120 of power generating cells electrically connected to the grid 122. The arrays are aligned at right angles to the flow of ocean tide and are electrically connected in parallel. Floats 124 are provided at the top of the arrays for alignment, location and tracking purposes. In a preferred embodiment the arrays are located near the breakwater point to capture the maximum amount of energy near the shore.

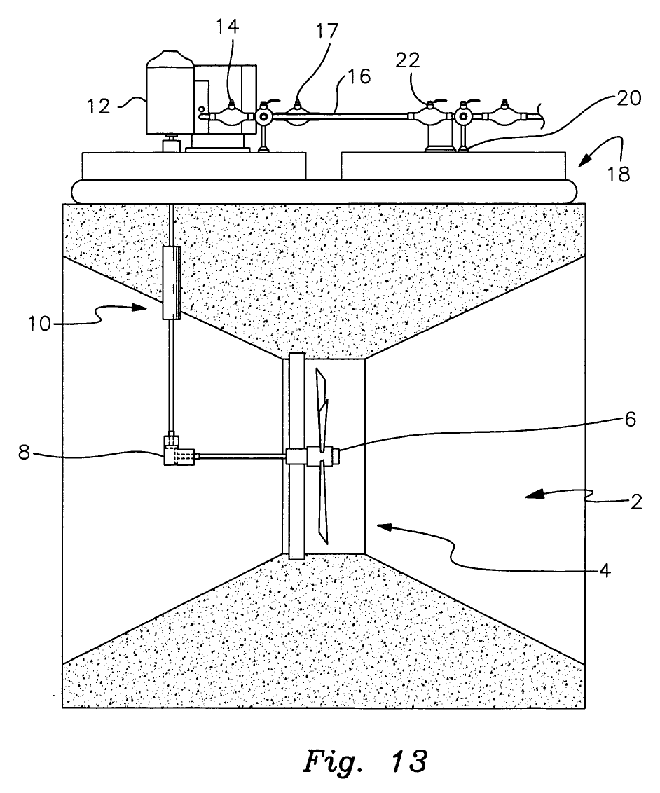

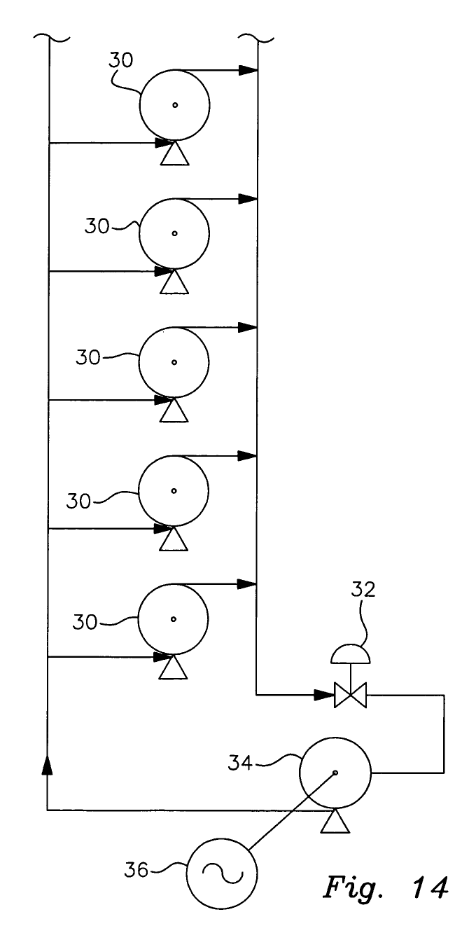

FIG. 13 shows a perspective view of the hydraulic pump system according to a preferred embodiment of the invention. Water from a river, dam, spillway, or other source, be it kinetic or head based, flows into the turbine housing from direction 2 toward turbine section 4. As water moves through turbine section 4, it drives turbine blade 6 which generates rotational mechanical power to gearbox 8. Gearbox 8 (which may contain gear ratio to increase the rotational rate of the shaft) in turn drives shaft 10 connected to hydraulic pump 12 for the creation of high pressure hydraulic fluid. Valve 14 transfers high pressure hydraulic fluid through valves 16 and 17 which are connected via a high pressure hydraulic fluid manifold to a hydraulic motor (not shown) for further conversion of power from high pressure fluid to a generator to generate electricity. The hydraulic pump and valves are positioned on platform 18 (which may be a temporary platform including barges and boats) which floats on the surface of the body of water that provides the water power. In one embodiment, a single turbine and hydraulic pump could provide hydraulic power to the hydraulic motor and then to the generator. In another configuration, a series of interconnected turbines and pumps could be utilized.

In a preferred embodiment, platform 18 could be fixed by anchoring to the ground below the water or attaching to a structure already in place which is driven into the ground below the water (for example a piling of a dock). Valves are supported on platform 18 by stanchions 16 and 20 and are interconnected with other hydraulic pumps on separate platforms in parallel or series fashion depending on the desired performance of the overall system. In one embodiment, a group of pumps and turbines can be configured to work in conjunction with each other and depending on the valve arrangements, valve 22 can be temporarily or permanently configured to bypass hydraulic pump 12 for servicing or if it needs to be taken off line for repair while at the same time maintaining operation of the other pumps on the platform or other platforms.

The turbines may be of any of a variety of well known configuration in the art such as a dual ducting venture design or non-ducted or single ducted depending on the application. The use of a series of interconnected turbine and hydraulic pumps allows for retrofit applications to flood control dams, recreational bodies of water created by dams, dam gates, spillways and other already pre-existing systems. In addition, an array of turbines and pumps could be used in tidal or ocean current settings, river current or in aqueducts and irrigation canals or effluent discharge from a man made orifice or pipe.

FIG. 14 shows a schematic diagram of a system of hydraulic pumps in parallel in a manner to transfer water generated energy from a series of turbines like that shown in FIG. 13. Hydraulic power in the form of pressurized fluid is transferred from the series of pumps 30 through a control governor 32 into a hydraulic motor 34. The output of the hydraulic motor is in turn applied to a generator preferably an AC induction generator having high efficiency. The hydraulic pumps may be the only portion of the overall system that are suspended over the water deriving their power from water driven turbines. This helps in reduced maintenance, reduced operational costs, and aids in disengagement of individual hydraulic pumps for servicing and repair. It further reduces the servicing and repair needs since the pumps are not in the water itself. An array of pumps 30 can be configured in any of a variety of manners to best utilize the flow of the water and to fit any particularities of the terrain.

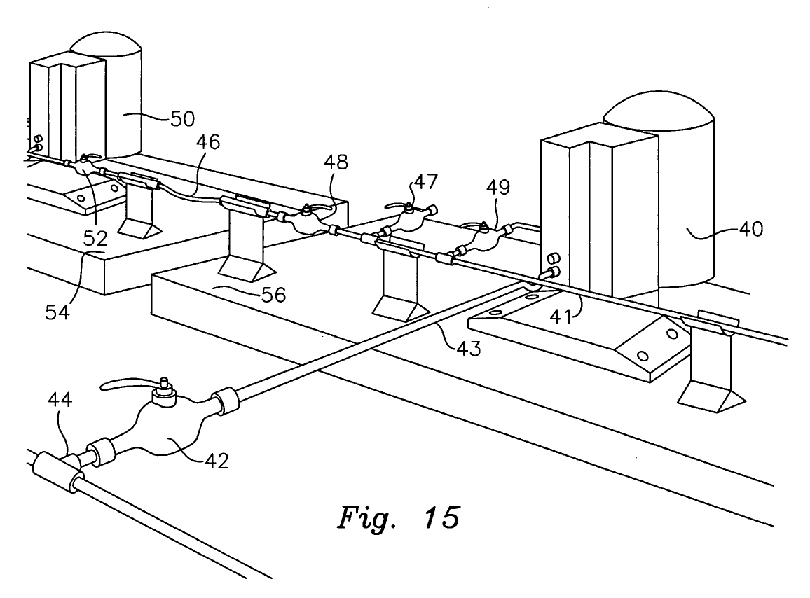

FIG. 15 shows an enlarged view of the hydraulic system according to a preferred embodiment of the invention using an array of hydraulic pumps on floating platforms. Pump 40 is fed with low pressure hydraulic fluid through line 41 which is a common manifold that delivers hydraulic fluid to the pump from a reservoir (not shown). High pressure hydraulic fluid is in turn generated through line 43 and passes through governor valve (not shown) and is tied into other high pressure fluid from other pumps through a series of valves which are connected to the manifold that interconnects all of the hydraulic pumps. Governor valve (not shown) permits better synchronization of the generator with the grid by controlling the connected hydraulic motor between the pump and the hydraulic motor on the array. These may be computer controlled for better efficiency in a manner well known in the art. Valves 42 and 49 are positioned on low pressure inlet and high pressure outlet to isolate hydraulic pump 40 in the event it needs to be taken off line for servicing or repair. Bridge line 46 is preferably flexible (such as flexible high pressure hose) as it provides a connection between platform 54 and platform 56 which are hydraulically separable through the low pressure bypass valves 47 and high pressure bypass valve (not shown). It further provides a moveable and flexible hydraulic line to permit independent movement of the platforms 54 and 56 relative to each other while positioned in the water.

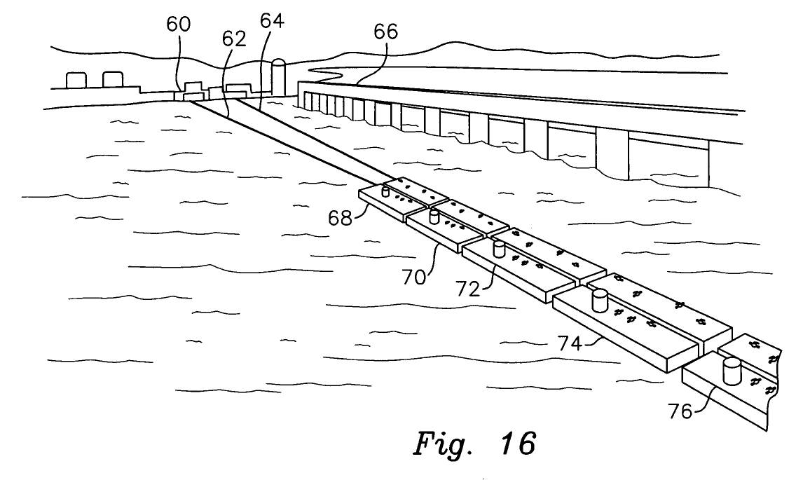

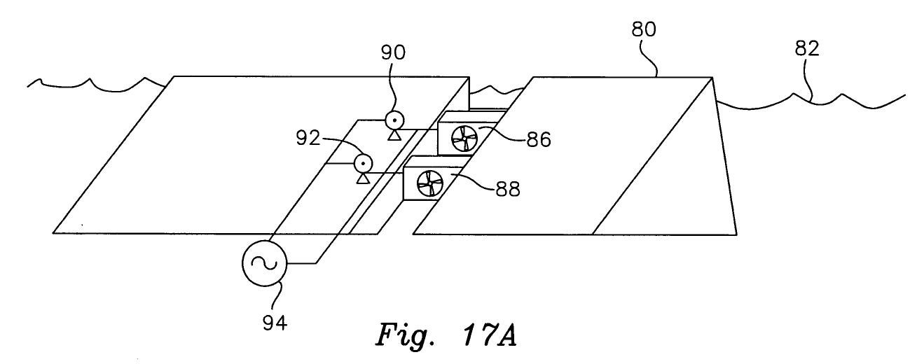

FIG. 16 shows an array of floating hydraulic pumps interconnected to each other and the generator and hydraulic motor on land via tether lines which also support the low pressure and high pressure hydraulic lines to and from the land and array. Platforms 68, 70 and 72 support hydraulic pumps configured as shown in FIG. 15. Low pressure line 62 which may be supported by a tether line or cable feeds hydraulic fluid at a low pressure to provide feed fluid for the hydraulic pumps. High pressure fluid is in turn generated from the pumps through high pressure line 64 supported by a tether line or cable, through the governor valve (on land, not shown) into a hydraulic motor which in turn is connected to an synchronous AC induction generator. The hydraulic pumps are driven by turbines that are suspended below the water from the platform (but could be anchored to the ground beneath the water).

The high efficiency synchronous AC induction generator (or other generator type) converts the mechanical energy of rotation into electricity based on electromagnetic induction. An electric voltage (electromotive force) is induced in a conducting loop (or coil) when there is a change in the number of magnetic field lines (or magnetic flux) passing through the loop. When the loop is closed by connecting the ends through an external load, the induced voltage will cause an electric current to flow through the loop and load. Thus rotational energy is converted into electrical energy. The induction generator produces AC voltage that is reasonably sinusoidal and can be rectified easily to produce a constant DC voltage. Additionally, the AC voltage can be stepped up or down using a transformer to provide multiple levels of voltages if required.

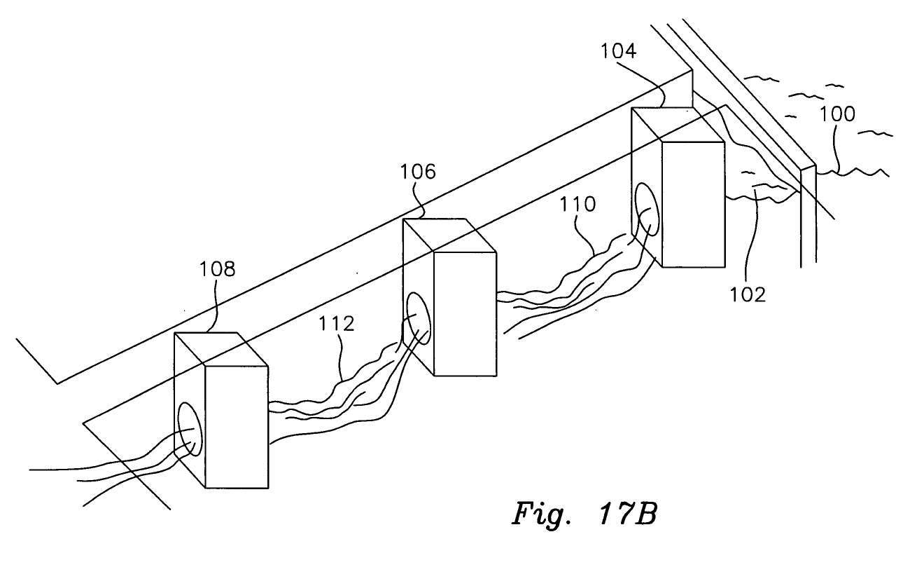

FIGS. 17A and 17B show placement of the system according to a preferred embodiment of the invention in a spillway or dam. FIG. 17A shows dam 80 in front of body of water 82. Spillway 84 permits the flow of water through a channel to engage turbines 86 and 88. Although only two turbines are shown, there may be any of a number of turbines depending on the size of the spillway and they could be arrayed in a plurality of locations in the spillway with hydraulically interconnected pumps driven by turbines. Hydraulic pumps 90 and 92 are positioned on the dam to receive rotational energy from the turbines which in turn generate hydraulic power through a hydraulic motor (not shown) to a generator 94. The turbines and pumps may be arrayed in any number depending on the application or the configuration of the dam. The turbines and pumps may be arranged in parallel or serial fashion but are preferably interconnected to maximize power. Further, by placing the hydraulic pumps outside of the flow of water, they may be easily interchanged, serviced or repaired without taking the entire system down as shown by the hydraulic bypass system in FIG. 15. FIG. 17B shows a side view of turbines 104, 106 and 108 positioned in the channel 102 which receives head water power from water source 100 as the water traverses down channel 102, it passes through turbine 104. As water passes through turbine 104 it cascades down the channel as water 110 which builds up behind turbine 106 to generate water power. Water that has passed through turbine 106 cascades as water 112 which in turn builds up and provides water power for turbine 108. Each of the turbines 104, 106 and 108 are connected to hydraulic pumps which are connected to a common manifold for generation of high pressure hydraulic fluid which in turn passes through a governor valve then drives a hydraulic motor and induction electric generator for the generation of electric power.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

I claim:

1. A system for power generation through movement of water comprising:
an array of turbine driven hydraulic pumps hydraulically interconnected;
said array composed of said pumps in a interchangeable modular arrangement;
said cells are positioned to receive kinetic energy from the movement of water, wherein said cells convert said energy by the movement of water through said turbine that drives said hydraulic pump.

2. A system for power generation through movement of water as claimed in claim 1 wherein at least one of said pumps is hydraulically isolatable from the others.

3. A machine for power generation through movement of water as claimed in claim 1 wherein said cells are connected to the electrical grid through a generator.

4. A machine for power generation through movement of water as claimed in claim 3 wherein said generator is an AC synchronous induction motor.

5. A machine for power generation as claimed in claim 1 wherein said hydraulic pumps are deployed on floating platforms (or can be fixed to the ground beneath the water) on a body of water.

6. A system for power generation through the movement of water comprising:
a plurality of hydraulic pumps arrayed in a modular configuration over a body of water;
a plurality of turbines in said water that receive kinetic energy from water for driving said turbines;
said pumps receive mechanical rotational power from said turbines to create high pressure fluid flow;
wherein said pumps drive at least one hydraulic motor for powering an electric generator.

7. A system for power generation through the movement of water as claimed in claim 6 wherein said arrays are moored to the ocean floor.

8. A system for power generation through the movement of water as claimed in claim 6 further comprising floats attached to said arrays to maintain a vertical alignment in the ocean.

9. A system for power generation through movement of water comprising:
a turbine displaced in a body of water from a platform where said turbine receives kinetic energy from said water;
an hydraulic pump driven by said turbine;
a manifold for receiving hydraulic pressurized fluid from said pump for driving a motor to generate electricity into the power grid.

10. A system for power generation through movement of water as claimed in claim 9 wherein said motor is an AC synchronous induction motor.

11. A system for power generation through movement of water as claimed in claim 9 further comprising a second hydraulic pump that is hydraulically independent from said first pump.

12. A system for power generation through movement of water as claimed in claim 11 further comprising a bypass valve for isolating said first pump from said second pump.
